(19) United States
(12) Patent Application Publication
(10) Pub. No.: US 2012/0148348 A1
(43) Pub. Date: Jun. 14, 2012

(54) System for reeling pipeline

(75) Inventors: Lyle Glennis Stockstill, New Orleans, LA (US); Lylyn Hingle Stockstill, New Orleans, LA (US)

(73) Assignee: Lylyn Hingle Stockstill

(21) Appl. No.: 12/928,602

(22) Filed: Dec. 14, 2010

(51) Int. Cl. F16L 1/00

(52) U.S. Cl. 405/170

(57) ABSTRACT

A pipe reeling system can be positioned in a location adjacent a dock to prepare spools of wound pipeline. The pipe segments are delivered to the facility from a steel mill or other manufacturer and placed on one or more pipe storage racks in a first orientation. The pipe segments are then moved to an elevated pipe feeding bed, from which they are fed in a second direction, transverse to the first direction through a plurality of weld stations. The pipe segments welded end-to-end form a continuous pipe unit, which is transferred to a spool and wound thereon. The spools can be prepared in advance of a request from a pipeline operator and stored in the facility on the reels until required.

### BACKGROUND OF THE INVENTION

This invention relates to a system for joining pipe ends together, such as for use in the offshore industry where in deep water, pipe sections are joined together to form a pipeline for deploying on the sea bottom.

The laying of pipeline on the sea bottom is accomplished by unwinding the pipeline from a reel positioned on a floating vessel, such as a barge. As the vessel moves forward, the reel rotates, thus allowing the pipeline to unwind and to be played over the stern of the vessel and into the water, where it is deployed on the sea floor. Prior to deployment or unloading of the pipeline from the vessel into the body of water, it is necessary to wind the pipeline onto the reel. This is usually accomplished on shore at an appropriate pipe-fabricating facility where joints of pipe are welded together and then loaded onto the reel.

However, transportation of such pre-loaded reels is complicated and expensive. Pipe-fabricating facilities are frequently located on inland waterways, and positioning of a suitable transport vessel in a small waterway often causes interruption of traffic through the waterway. As a consequence, it becomes necessary either to interrupt the loading process and move the transport vessel to allow another to pass, or to establish a precise schedule when the transport vessel can be allowed into the inland waterway.

Additionally, the operators of offshore platforms often send their orders for a particular type and diameter pipe to a docking facility. Since it takes a considerable amount of time to have the reels prepared and transported to a sea-side dock, the pipe-manufacturing facilities need to carefully estimate the delivery time so as not to lose a customer.

There exists therefore a need for a pipe reeling system that can be established in any desirable location near a sea dock, so that pre-loaded reels with pipe of the pre-selected type and diameter can be expeditiously loaded to a vessel for delivery to an offshore rig.

The present invention contemplates elimination of drawbacks associated with conventional reeling systems and provision of a pipe-reeling system that can be set up for operation in a dockside location.

### SUMMARY OF THE INVENTION

It is, therefore, an object of the present invention to provide a pipe reeling system that can be positioned dockside to allow welding of lengths of pipe end-to-end in a plurality of weld stations.

It is another object of the invention to provide a pipe reeling system that allows reeling of pipe length in a dockside location after they pipe lengths have been welded together.

It is a further object of the invention to provide a pipe reeling system that has a means for loading of reeled pipeline on a floating vessel positioned adjacent the welding and reeling facility.

These and other objects of the invention are achieved through a provision of A pipe reeling system can be positioned in a location adjacent a dock to prepare spools of wound pipeline. The pipe segments are delivered to the facility from a steel mill or other manufacturer and placed on one or more pipe storage racks in a first orientation. The pipe segments are then moved to an elevated pipe feeding bed, from which they are fed in a second direction, transverse to the first direction through a plurality of weld stations. The pipe segments welded end-to-end form a continuous pipe unit, which is transferred to a spool and wound thereon. The spools can be prepared in advance of a request from a pipeline operator and stored in the facility on the reels until required.

### BRIEF DESCRIPTION OF THE DRAWINGS

Reference will now be made to the drawings, wherein like parts are designated by like numerals, and wherein

FIG. 1 is a perspective view of the pipeline reeling system of the present invention.

FIG. 2 is perspective view of the pipeline reeling system of the present invention showing the waterside view of a transport barge.

FIG. 3 is a detail view of a weld station used in the system of the present invention.

FIG. 4 is a detail view of the reel assembly with a spool mounted on a movable carriage.

FIG. 5 is a detail view of a stationary line-up roller module supporting a length of pipe showing the front of the roller module.

FIG. 6 is a detail view of a stationary line-up roller module supporting a length of pipe showing the back of the roller module.

### DETAIL DESCRIPTION OF THE INVENTION

Turning now to the drawings in more detail, numeral 10 designates the pipeline reeling system of the present invention. The system 10 is located onshore at a dockside facility located adjacent a dock 12. The system 10 comprises a pipe storage rack assembly 20, a feeding assembly 32, a weld station assembly 22, a reeling assembly 24, a reel storage assembly 26, and a means 28 for moving the reels. The different assemblies that form parts of the system of the present invention are arranged to work in synchronism, moving the pipe units from the storage rack assembly to the finished reels, ready for transport to an offshore rig upon demand.

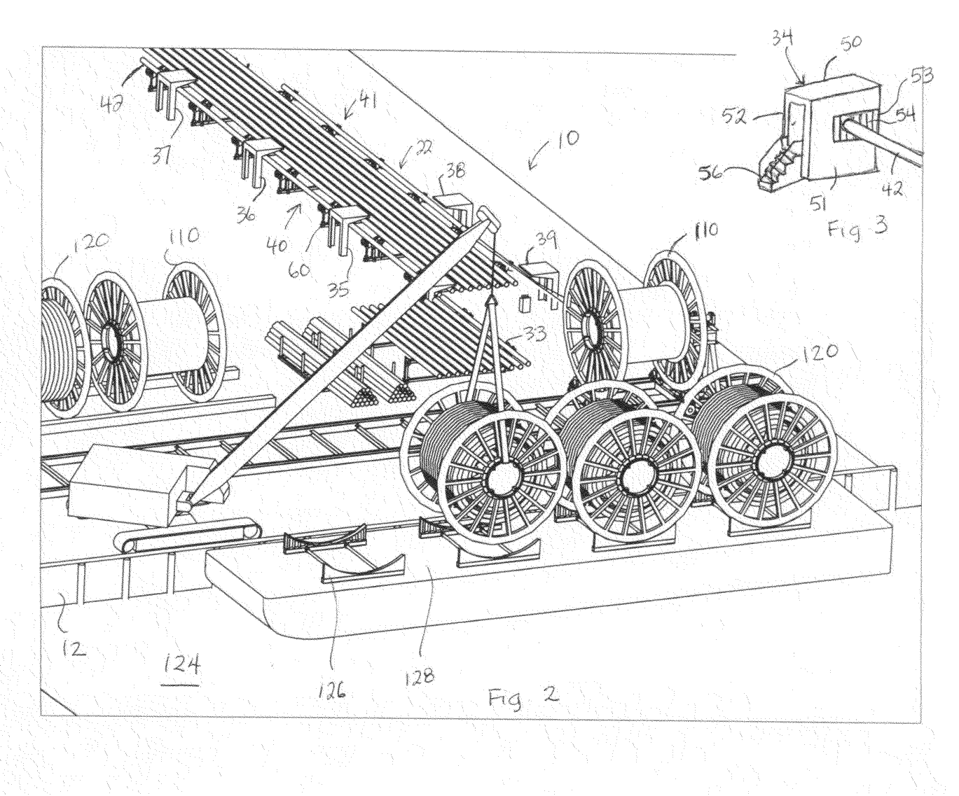

The pipe storage rack assembly 20 comprises one or more storage racks 30 where lengths or segments of pipe 31 of predetermined type and diameter are stored in the facility. The pipe lengths may be delivered to the facility on trucks, stacked in a pyramidal fashion, as shown in FIG. 2 and unloaded on the ground for storage in the racks 30. The pipe segments are store on the racks 30 in a first orientation.

A stationary elevated horizontal pipe feeding rack or feeding assembly 32 is located immediately adjacent to the pipe storage racks 30. The pipe feeding rack 32 has a pipe feeding bed that is elevated in relation to the ground to a height convenient for moving the pipe segments 31 along a horizontal plane. The feeding rack 32 comprises upright supports connected by two or more horizontal rails, which support the pipe segments 31 and move them from the downstream side of the feeding rack adjacent the storage racks 30 to the weld station assembly 22 on the upstream side of the feeding rack 32.

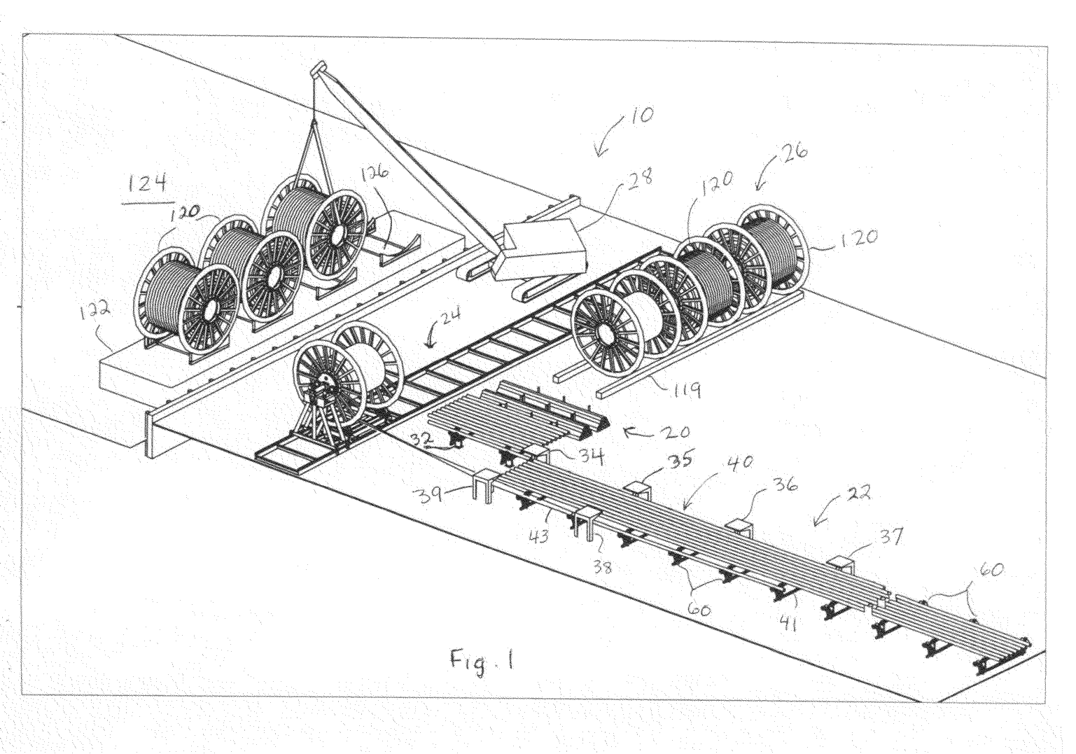

As can seen in FIGS. 1 and 2, the pipe units 31 are rolled along the rails of the feeding assembly 32 in a direction transversely to the longitudinal axes of the pipe segments 31 and substantially parallel to the first orientation of the pipe segments 31. When the forwardmost pipe unit 33 is in a position axially aligned with the weld assembly 22, the pipe segment 33, and the other pipe units thereafter, is transferred to the weld assembly 22. At that time, the pipe segments 31 are moved in a second direction, transversely to the first direction and co-axially with the axes of the pipe segments 31.

The weld assembly 22 comprises a plurality of spaced weld stations 34, 35, 36, 37 and 38. The weld stations 34-37 are located along a first side 40 of the weld station assembly 22, while the final weld station 38 is located on an opposite side 41 of the weld station assembly 22. A weld station 34 is illustrated in FIG. 3. It will be understood that other weld stations are similar in construction to the weld station 34.

The weld station 34 comprises an enclosure 50 having an inlet side 51 and an outlet side 52. The enclosure 50 protects the welder and the weld location from the elements. A cutout 53 is formed in each side 51 and 52 (only one such cutout is seen in FIG. 3) to allow the elongated pipe unit 42 to pass from the inlet side 51 to the outlet side 52. A curtain 54 may be provided to cover the cutouts 53 while the welding operation takes place within the enclosure 50. If necessary access steps 56 may be provided to allow a welder to enter the enclosure 50 and conduct the welding operation. As the welding progresses, the elongated pipe unit 42 is fed through the weld station 34 from the inlet side 51 to the outlet side 52.

The pipe segment 33 is transferred laterally to the first side 40 of the weld station assembly 22, where the pipe unit 33 is welded to a length of pipe or a continuous elongated pipe unit 42. The initial weld is made at the weld station 34, and subsequent weld are performed at successive weld stations 35, 36, and 37. Once the elongated pipe unit 42 is of a predetermined length, for instance 400 feet long, the elongated pipe unit 42 is rolled to the side 41 of the weld station assembly 22 in a direction transverse to the longitudinal axis of the continuous elongated pipe unit 42.

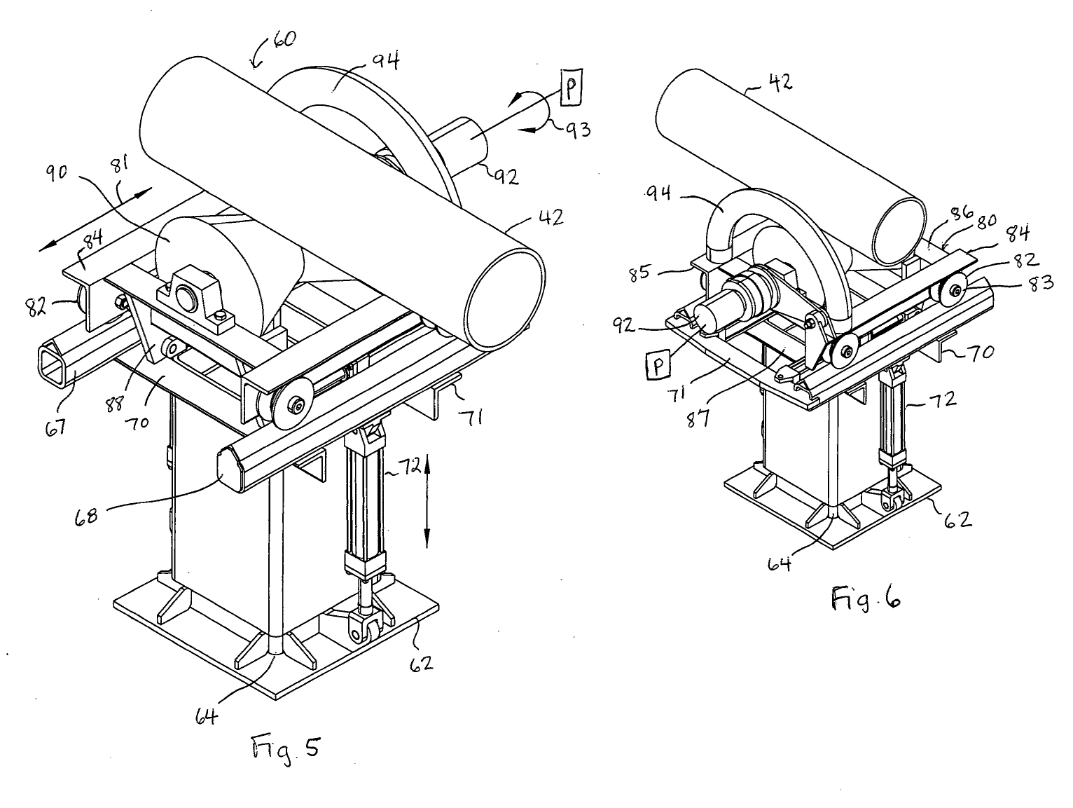

To facilitate movement of the elongated pipe units along the weld station assembly 22, the system of the present invention provides for a plurality of roller assemblies 60, one of which is shown in FIG. 5. The roller assemblies 60 line up the segments of pipe between the roller assemblies 60 and the weld station assemblies 34-37 so as to allow formation of the elongated pipe units 42 for subsequent spooling.

As can be seen in the drawings, each roller assembly 60 comprises a base 62 that is configured to rest on the ground. The base 62 can be square or rectangular in configuration. A plurality of upright supports 64 extends upwardly from the base 62 supporting a pair of parallel roller tracks 67 and 68.

The roller tracks 67 and 68 are connected by transverse L-shaped brackets bars 70, 71. A pair of powered jacks, for instance hydraulic jacks 72, 73 engages the underside of the roller tracks 67, 68. The powered jacks 72, 73 are configured to vertically align the roller tracks 67 and 68 so as to smoothly move the elongated pipe unit 42 within the weld station assembly 22.

A roller carriage 80 is configured for a limited lateral back-and-forth movement along the roller tracks 67, 68 in the direction of arrow 81. The roller carriage 80 comprises a plurality of roller wheels 82 configured for rolling engagement with the upper surfaces of the roller tracks 67 and 68. The shafts 83 of the roller wheels 82 are engaged within spaced-apart upper brackets 84 and 85.

Spacer plates 86 and 87 extend between the upper brackets 84, 85. The spacer plates 86 and 87 are supported by upwardly extending blocks 88, which rest on the transverse bars 70, 71. A generally conical pipe roller 90 is secured between the spacer plates 86, 87. The pipe roller 90 is configured for an axial rotational movement about an axis defined by a roller shaft 92. The roller shaft 92 is configured for operational connection to an external power source for receiving rotational force and transmitting the rotational force to the pipe roller 90. The roller shaft 92 and the pipe roller 90 rotate about the shaft axis in the direction of arrow 93.

A means for limiting transverse movement of the elongated pipe unit 42 on the carriage 80 is provided in the form of an arcuate bumper 94, which is mounted on the upper brackets 84, 85 adjacent to the back portions of the upper brackets. Since the pipe roller 90 is positioned on the carriage 80 with its largest diameter part facing the front of the roller assembly 60, the elongated pipe units 42 have a tendency of rolling toward the smaller diameter portion of the conical pipe roller 90. The bumper 94 prevents the elongated pipe units from sliding off the carriage 80, while allowing the elongated pipe units to freely rotate about the longitudinal axes thereof.

As the elongated pipe units 42 are formed, they are each transferred from the first side 40 of the roller station assembly 22 to the second side 41 thereof. One such unit is designated by numeral 43 in the drawings. The continuous elongated pipe unit 43, which can be 400-feet in length or more, is moved axially along the roller assemblies 60 to the final weld station 38, where the operator makes a final check of the welding seams between the pipe segments 33. If desired, a portable X-ray station may be positioned at the final weld station 38 to allow inspection of the weld seams in the pipe unit 42. The pipe unit 43 can be also pressure-tested and anodes applied thereto.

A label station 39 is positioned downstream of the weld station 38. A suitable labeling device (not shown) is positioned at the label station 39. The labels and codes are applied to the pipe unit 43 with indicia designating the type of pipe and the pipe diameter of the pipe unit 43. If desired other indicia may be imprinted on the labels as well.

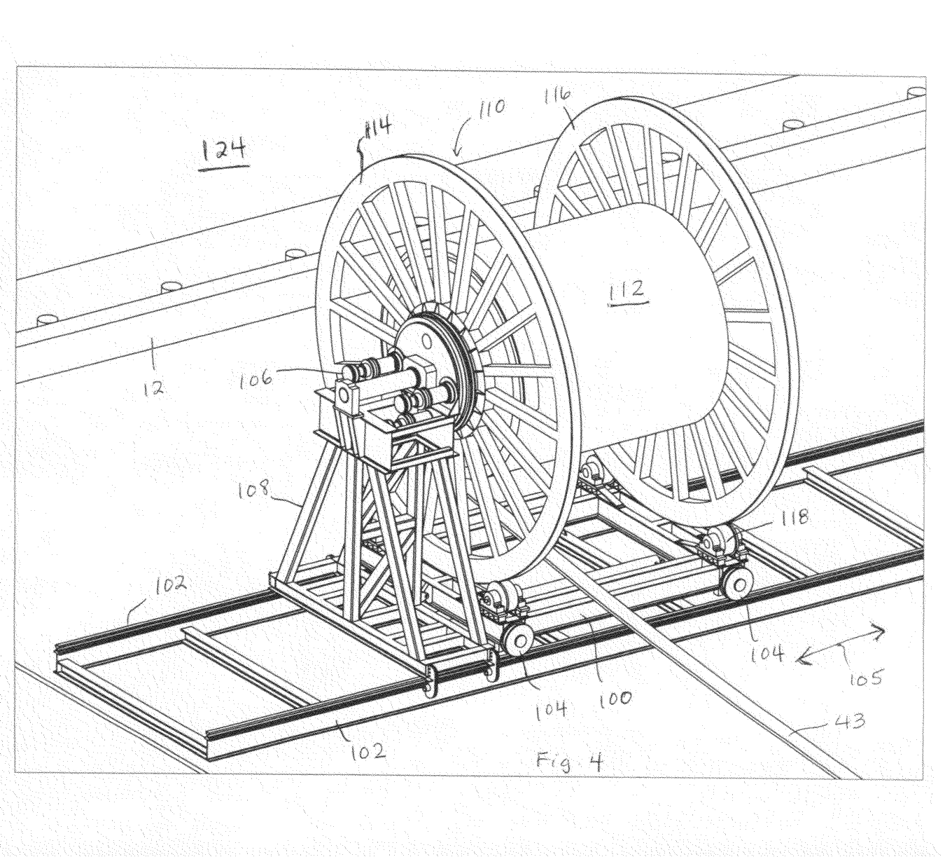

As the pipe unit 43 leaves the label station 39, it is fed towards the reeling assembly 24, where a wagon 100 is positioned on a rail track 102. The wagon 100 has rolling wheels 104, which engage with the top surfaces of the rail track 102. The wagons 102 are configured for horizontal movement along the rail tracks 102, as indicated by arrow 105 in FIG. 4.

A power unit 106 is mounted on a support tower 108, which support the power unit 106 in an elevated position above the rail track 102. The power source 106 may be a hydraulic motor or any other available power source. The support tower 108 is stationary in relation to the rail track 102, while the wagon 100 moves along the rail tracks 102 toward and away from the support tower 108 with its power source 106.

A spool 110 is detachably positioned on the wagon 100. The spool 110 has a cylindrical drum 112, on which the pipe unit 43 is reeled. The spool 110 is provided with flanges 114 and 116 on opposite ends of the drum 112. The flanges 114 and 116 each have a greater diameter than the diameter of the drum 112, thus allowing a length of pipe to be looped around the drum 112. Once the pipe unit 43 is wound on the spool 110, another such pipe unit is welded, end-to-end to the pipe unit 43 and so forth. In one aspect of the invention, the pipeline would on the spool 110 can be more than 30,000-feet long.

The wagon 100 is provided with two sets of rotatable members 118, which engage the flanges 114, 116 while the spool 110 is rotated by the power source 106. Once the desired length of the tubular has been reeled on the spool 110, the operator disconnects the spool 110 from the power source 106 and allows the wagon 100 to be moved along the rail tracks 102 to a location along the tracks closer to the means 28 for moving the reels. The means 28 can be a crane or other suitable lifting assembly.

The crane 28 lifts the reel 110 from the rail tracks 102 and moves them to a reel storage assembly 26, where ready spools 120 with lengths of pipe wound thereon are stored until they are transported from the pipe reeling facility 10. The reel storage assembly comprise a pair of parallel rods 118, 119 positioned on the ground. The rods 118, 119 define the space where the reels 110 and 120 can be positioned. The rods 118 and 199 prevent rolling of the reels on the ground.

The reel storage facility can also be used to store empty spools 110, as can be seen in FIGS. 1 and 2. The crane 28, being positioned adjacent the water edge on the dock 12 can pivot and move the spools 110 from the reeling assembly 24 to the reel storage assembly 26.

Once an order for the pipes of a particular diameter is received, the facility operator can transfer any of the loaded reels 120, using the crane 28 to a floating transport vessel 122. The transport vessel 122 floats in the body of water 124. Conventional floating transport vessels 124 are equipped with cradles 126 that support the reels on the deck 128 of the barge 122. The cradles 126 are arranged to retain the reels 120 during transportation. If desired, the pipeline 43 can be played out directly from the reels 120 and allow the pipeline 43 to be laid on the sea bottom. When the loaded reels are positioned on the barge 122 as shown in FIGS. 1 and 2, the pipeline 43 can be spooled off the reels 120 directly into the water and laid along a line of movement of the barge 122.

In operation, the segments of pipe 31 are delivered and store on the racks 30 in the facility where the system 10 is installed. The operators manually or using any available lifting equipment transfer individual pipe segments 31 to the feeding assembly 32. The pipe segments are moved along the feeding assembly to a position axially aligned with the weld assembly 22. The forwardmost pipe segment 33, and the other pipe units thereafter, is transferred to the weld assembly 22.

Once a sufficient number of pipe segments have been delivered to the weld assembly 22, the welders located in the weld stations 50 perform the welding operations to form an elongated pipe length of about 400 feet or more. The finished length of pipe 43 is rolled to the other side of the weld station assembly 22 using the rollers 60, where operator(s) causes the pipe unit 43 to be moved axially in the direction of the final weld inspection station 38, where the pipe unit 43 can be inspected, X-rayed, pressure-tested, anodes placed, etc.

From the final weld/inspection station 38, the pipe unit 43 is moved axially to the label station 39, where the pipe unit 43 is coded and labeled, and then—to the spool 110 mounted on the reel support assembly 24. The pipe unit 43 is then rolled on the spool 110. Once the pre-determined length of pipe has been wound on the spool 110, the loaded spool is transferred to the reel storage assembly 26. The spooled tubular are now ready for transport to the offshore rig in an efficient manner.

The operator of the system 10 can buy the pipe segments from the pipe manufacturing company, for instance U.S. Steel, at the size most popular in the location and have them pre-shipped to the reeling facility where the system 10 is installed. The pipeline is welded, inspected, x-rayed, coded, and then hydraulically wound up on the spools at the facility. The pipeline is then available for sale to an oil company that needs a four-inch or six-inch pipe run from some particular platform offshore into the pumping station onshore.

The advantages of this system is that the pipe instead of sitting at U.S. Steel in racks, is pre-welded, pre-coded, pre-x-rayed, pre-tested, rolled up in to about 6-mile segments (over 30,000 feet), and is stored on a dock to be easily transported to the location for the pipeline such that it can be laid expeditiously.

In addition to the rolls of pipe being on land and ready for transportation to the site via the transport barge, it is envisioned that the reels (spools) of pipe may be positioned on the barge as they are finished so that as the pipes are needed, particularly in an emergency situation, the spools are already in place on the barge to be moved to the location for laying. The system 10 allows the facility where the system 10 is installed to provide the finished product, an important certification to the well's owner, the x-rays and the appropriate coding including the anode leads. It is noted that the anodes were not conventionally placed on the pipe until such time as it was spooled out. The instant system allows elimination of this step offshore since all necessary pipeline preparation is carried out at the pipe reeling facility using the system of the instant invention.

Many changes and modifications and modifications can be made in the design of the present invention without departing from the spirit thereof. I, therefore, pray that my rights to the present invention be limited only by the scope of the appended claims.

I claim:

1. A system for reeling a pipeline, comprising:
a pipe storage rack assembly configured for storing a plurality of pipe segments in a first orientation;
a feeding assembly aligned with the pipe storage rack assembly for moving the pipe segments in a first direction;
a weld station assembly positioned adjacent to the feeding assembly, said weld station assembly being configured for receiving the pipe segments from said feeding assembly in a second direction transversely to the first direction;
a reeling assembly positioned adjacent the weld station assembly, said reeling assembly being configured to receive a pre-determined length of pipe from the weld station assembly and at least one spool, said at least one spool being configured to receive in a winding manner the pre-determined length of pipe;
a reel storage assembly configured for retaining spools and positioned adjacent the reeling assembly; and
a means for moving the reels positioned adjacent the reeling assembly and the reel storage assembly.

2. The system of claim 1, wherein the pipe storage assembly comprises a plurality of racks configured for storing a plurality of pipe segments.

3. The system of claim 1, wherein the feeding assembly comprises a stationary pipe feeding rack with an elevated bed, said elevated bed being configured for supporting the pipe segments in an orientation substantially parallel to the first orientation and for moving the pipe segments in a direction substantially transversely to longitudinal axes of the pipe segment.

4. The system of claim 1, wherein the weld station assembly comprises a plurality of spaced weld stations located on a first downstream side of the weld station assembly and at least one weld/inspection station located on a second upstream side of the weld station assembly.

5. The system of claim 4, wherein said weld stations are configured for connecting a plurality of pipe segments end-to-end and forming continuous pipe units of a predetermined length.

6. The system of claim 5, wherein the weld/inspection station is configured for examining and testing of weld joints in the continuous pipe units.

7. The system of claim 5, wherein the weld station assembly is configured to moving the continuous pipe units from the first downstream side to the second upstream side in a direction substantially transverse to longitudinal axes of the continuous pipe units.

8. The system of claim 4, wherein each of the weld stations comprises an enclosure configured for accommodating a welder during a welding operation.

9. The system of claim 5, wherein the weld station assembly further comprises a plurality of roller assemblies configured to support the pipe segments received from the feeding assembly in a co-axial aligned relationship to each other.

10. The system of claim 9, wherein each roller assembly comprises a base configured to rest on the ground, a plurality of upright supports extending upwardly from the base, and a pair of parallel roller tracks supported by the upright supports.

11. The system of claim 10, wherein the roller tracks are connected by transverse L-shaped brackets bars.

12. The system of claim 10, further comprising a plurality of powered jacks configured to engage an underside of the roller tracks, said powered jacks being adapted to vertically align the roller tracks and facilitate aligned movement of the pipe segments and the continuous pipe units within the weld station assembly.

13. The system of claim 10, wherein each roller assembly further comprises a roller carriage configured for a limited lateral back-and-forth movement along the roller tracks.

14. The system of claim 13, wherein the roller carriage comprises a plurality of roller wheels configured for rolling engagement with upper surfaces of the roller tracks.

15. The system of claim 13, wherein the roller carriage further comprises a generally conical pipe roller connected to a roller shaft, said pipe roller being configured for an axial rotational movement about an axis defined by the roller shaft.

16. The system of claim 15, wherein said roller shaft is configured for connection to an external power source for receiving rotational force and transmitting the rotational force to the pipe roller.

17. The system of claim 15, further comprising a means for limiting transverse movement of the continuous pipe unit on the roller carriage, said movement limiting means comprises an arcuate bumper secured to the roller carriage and extending upwardly therefrom.

18. The system of claim 1, wherein the reeling assembly comprises a wheeled wagon configured for positioning on a rail track and configured for horizontal movement along the rail tracks.

19. The system of claim 18, wherein the reeling assembly further comprises a stationary power unit mounted on a support tower, said support tower being mounted on the rail tracks.

20. The system of claim 18, wherein said at least one spool is detachably positioned on the wagon during a pipe reeling operation.

21. The system of claim 1, wherein said means for moving the reels comprises a crane.

22. A system for reeling a pipeline, comprising:
a pipe storage rack assembly comprising a plurality of pipe racks, each of the pipe racks being configured for storing a plurality of pipe segments in a first orientation;
a feeding assembly aligned with the pipe storage rack assembly for moving the pipe segments in a first direction, said feeding assembly comprising a stationary pipe feeding rack with an elevated bed, said elevated bed being configured for supporting the pipe segments in an orientation substantially parallel to the first orientation and for moving the pipe segments in a direction substantially transversely to longitudinal axes of the pipe segments;
a weld station assembly positioned adjacent to the feeding assembly, said weld station assembly being configured for receiving the pipe segments from said feeding assembly in a second direction transversely to the first direction, said weld station assembly comprising a plurality of spaced weld stations located on a first downstream side of the weld station assembly and at least one weld/inspection station located on a second upstream side of the weld station assembly;
a reeling assembly positioned adjacent the weld station assembly, said reeling assembly being configured to receive a pre-determined length of pipe from the weld station assembly and at least one spool, said at least one spool being configured to receive in a winding manner the pre-determined length of pipe;
a reel storage assembly configured for retaining spools and positioned adjacent the reeling assembly; and
a means for moving the reels positioned adjacent the reeling assembly and the reel storage assembly.

23. The system of claim 22, wherein said weld stations are configured for connecting a plurality of pipe segments end-to-end and forming continuous pipe units of a predetermined length.

24. The system of claim 22, wherein the weld/inspection station is configured for examining and testing of weld joints in the continuous pipe units.

25. The system of claim 22, wherein the weld station assembly is configured to moving the continuous pipe units from the first downstream side to the second upstream side in a direction substantially transverse to longitudinal axes of the continuous pipe units.

26. The system of claim 22, wherein each of the weld stations comprises an enclosure configured for accommodating a welder during a welding operation.

27. The system of claim 22, wherein the weld station assembly further comprises a plurality of roller assemblies configured to support the pipe segments received from the feeding assembly in a co-axial aligned relationship to each other.

28. The system of claim 27, wherein each roller assembly comprises a base configured to rest on the ground, a plurality of upright supports extending upwardly from the base, and a pair of parallel roller tracks supported by the upright supports.

29. The system of claim 28, wherein the roller tracks are connected by transverse L-shaped brackets bars.

30. The system of claim 28, further comprising a plurality of powered jacks configured to engage an underside of the roller tracks, said powered jacks being adapted to vertically align the roller tracks and facilitate aligned movement of the pipe segments and the continuous pipe units within the weld station assembly.

31. The system of claim 28, wherein each roller assembly further comprises a roller carriage configured for a limited lateral back-and-forth movement along the roller tracks.

32. The system of claim 31, wherein the roller carriage comprises a plurality of roller wheels configured for rolling engagement with upper surfaces of the roller tracks.

33. The system of claim 31, wherein the roller carriage further comprises a generally conical pipe roller connected to a roller shaft, said pipe roller being configured for an axial rotational movement about an axis defined by the roller shaft.

34. The system of claim 33, wherein said roller shaft is configured for connection to an external power source for receiving rotational force and transmitting the rotational force to the pipe roller.

35. The system of claim 31, further comprising a means for limiting transverse movement of the continuous pipe unit on the roller carriage, said movement limiting means comprises an arcuate bumper secured to the roller carriage and extending upwardly therefrom.

36. The system of claim 22, wherein the reeling assembly comprises a wheeled wagon configured for positioning on a rail track and configured for horizontal movement along the rail tracks.

37. The system of claim 36, wherein the reeling assembly further comprises a stationary power unit mounted on a support tower, said support tower being mounted on the rail tracks.

38. The system of claim 36, wherein said at least one spool is detachably positioned on the wagon during a pipe reeling operation.
